(19) United States
(12) Patent Application Publication
(10) Pub. No.: US 2005/0233807 A1
(43) Pub. Date: Oct. 20, 2005

(54) Massage chair controller capable of providing games

(75) Inventor: Johnny Tai, Dong Guan City (CN)

Correspondence Address: NIKOLAI & MERSEREAU, P.A., 900 SECOND AVENUE SOUTH, SUITE 820, MINNEAPOLIS, MN, 55402, US

(73) Assignee: Hsiu-Hsueh Wu, Ta Li City (TW)

(21) Appl. No.: 10/827,503

(22) Filed: Apr. 19, 2004

(51) Int. Cl. A63F 13/00

(52) U.S. Cl. 463/36

(57) ABSTRACT

A controller is disclosed for use in a massage chair with vibrators and capable of providing games. The controller includes a display, an input device for input of commands, a selection module connected with both of the display and the input device, a game module connected with the selection module in order to provide various games and a massage module connected with the selection module on one hand and connected with the vibrators on the other hand so as to actuate various combinations of the vibrators.

### FIELD OF THE INVENTION

The present invention relates to a massage chair controller capable of providing games.

### BACKGROUND OF THE INVENTION

In a conventional massage chair, there are provided various massage modes, e.g., a single-point massage or a circulating massage. To this end, the massage chair must be equipped with a controller for a user to use to select massage modes. The controller provides only one function, i.e., the selection of the massage modes. The controller is idle after one of the message modes is selected.

The present invention is therefore intended to obviate or at least alleviate the problems encountered in prior art.

### SUMMARY OF THE INVENTION

The primary objective of the present invention is to provide a massage chair with a controller capable of providing games.

According to the present invention, a controller is disclosed for use in a massage chair with vibrators and capable of providing games. The controller includes a display, an input device for input of commands, a selection module connected with both of the display and the input device, a game module connected with the selection module in order to provide various games and a massage module connected with the selection module on one hand and connected with the vibrators on the other hand so as to actuate various combinations of the vibrators.

Other objects, advantages, and novel features of the invention will become more apparent from the following detailed description when taken in conjunction with the attached drawings.

### BRIEF DESCRIPTION OF DRAWINGS

The present invention will be described through detailed illustration of two embodiments referring to the drawings.

FIG. 1 is a perspective view of a massage chair equipped with a controller capable of providing games according to the first embodiment of the present invention.

FIG. 2 is a perspective view of the controller shown in FIG. 1.

FIG. 3 is a block diagram of a circuit used in the controller of FIG. 2.

FIG. 4 is a perspective view of a user sitting on the massage chair and play electronic games with the controller of FIG. 1.

FIG. 5 is similar to FIG. 4 but shows a user using a wireless controller according to the second embodiment of the present invention.

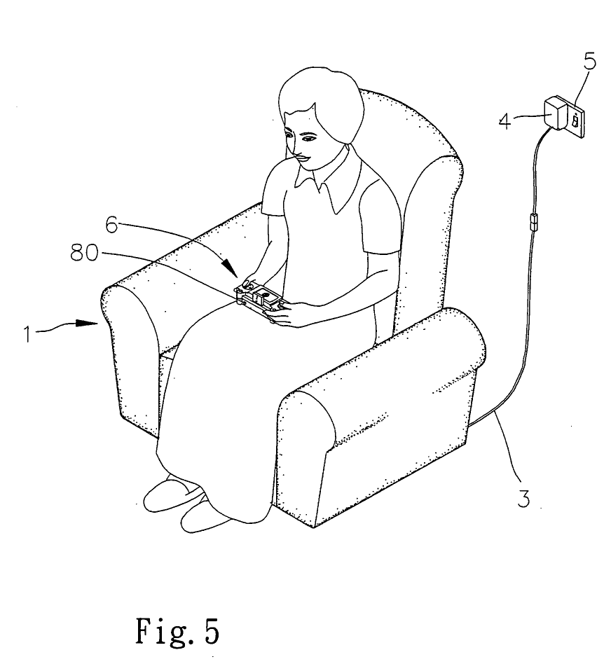

### DETAILED DESCRIPTION OF EMBODIMENTS

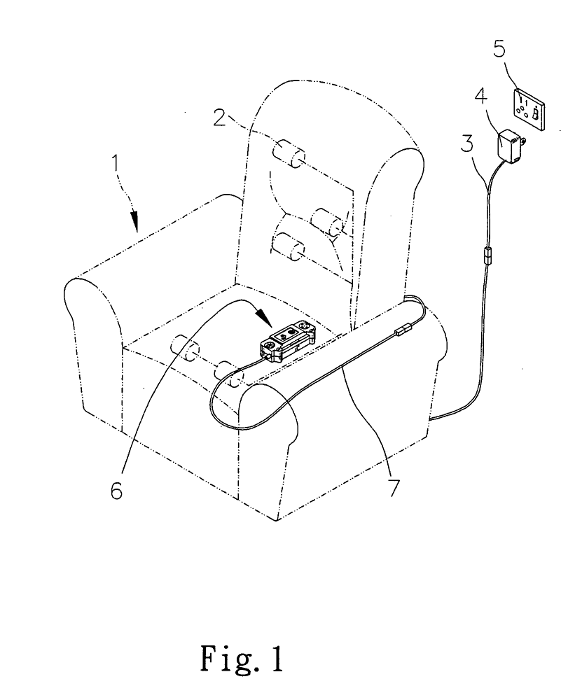

Referring to FIG. 1, according to a first embodiment of the present invention, a typical massage chair 1 includes a seat (not numbered), a backrest (not numbered), at least one vibrator 2 installed in the seat, at least one vibrator 2 installed in the backrest and a controller 6 connected with the vibrators 2. The controller 6 is capable of providing games.

The vibrators 2 are connected with a transformer 4 through a power supply cord 3. The transformer 4 can be plugged in a socket 5 so that power can be provided for the vibrators 2. In this condition, the vibrators 2 can vibrate so as to message a user at various points.

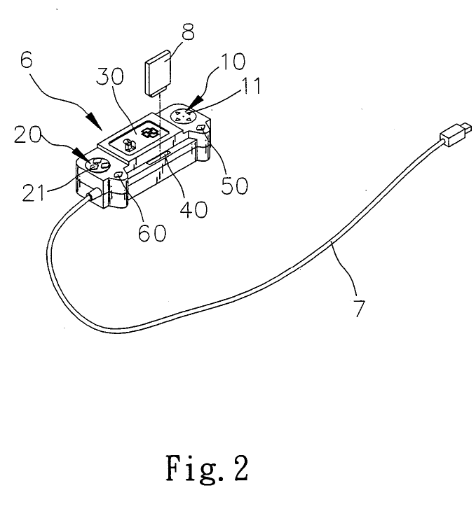

Referring to FIG. 2, the controller 6 includes a first button group 10, a second button group 20 and a display 30. The first button group 10 includes four direction buttons 11 for moving a cursor in the display 30. The second button group 20 includes three action buttons 21. The action buttons 21 can be pushed so as to conduct actions available in a game. Moreover, the action buttons 21 can be pushed so as to select massage modes. The controller 6 includes a confirmation button 50 near the first button group 10 and a selection button 60 near the second button group 20. The controller 6 includes a slot 40 located near the display 30 in order to receive a game card 8.

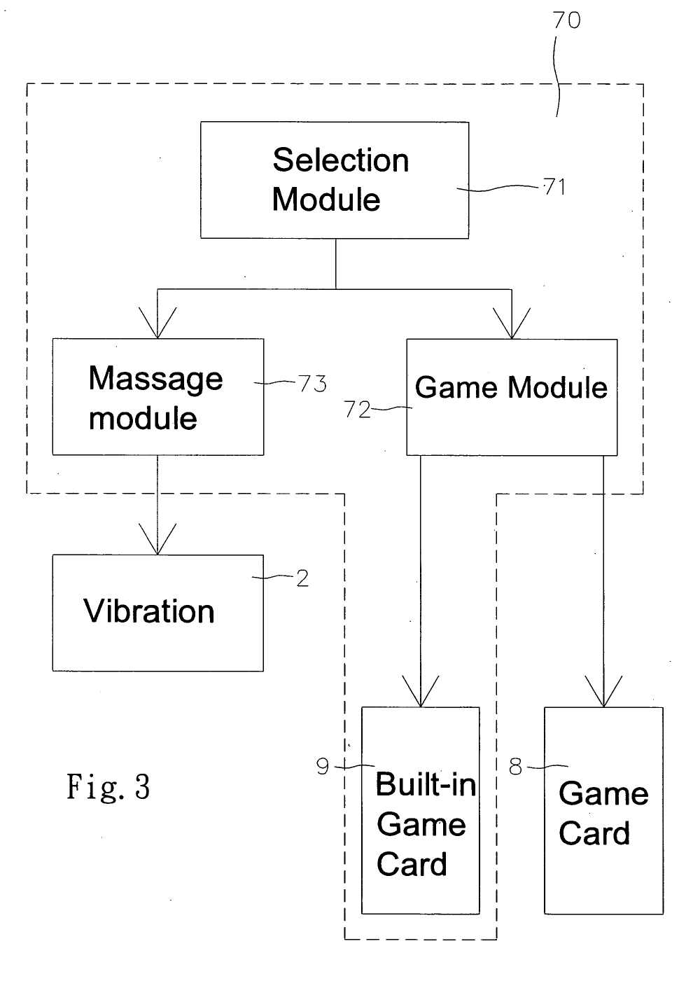

FIG. 3 shows a circuit 70 used in the controller 6 of FIG. 2. The circuit 70 includes a selection module 71, a game module 72, a built-in game card 9 and a massage module. The selection module 71 is connected with all of the first button group 10, the second button group 20, the display 30, the confirmation button 50 and the selection button 60. The game module 72 is connected with the selection module 71. A built-in game card 9 is connected with the game module 72. Moreover, the game module 72 is connected with the slot 40 through which the game card 8 is connected with the game module 72. The massage module 73 is also connected with the selection module 71. The vibrators 2 are connected with the message module 73.

When the controller 6 is turned on, a message is displayed on the display 30 in order to prompt the user to select from a game mode and a massage mode. If the game mode is selected, the game module 72 is actuated. If the massage mode is selected, the massage module 73 is actuated. The user can operate the first button group 10, the second button group 20, the confirmation button 50 and the selection button 60 in order to select from the modes.

The massage module 73 connects the first button group 10, the second button group 20, the display 30, the confirmation button 50 and the selection button 60. The massage module 73 transmits signals to the vibrators 2 by means of a cable 7 (shown in FIG. 2). Thus, the vibrators 2 can be started to oscillate.

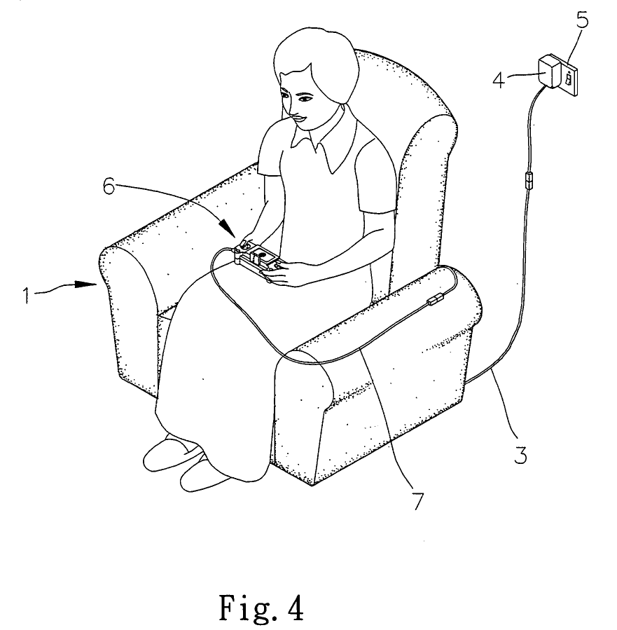

Referring to FIG. 4, the user is sitting on the chair 1 and using the controller 6 to select from the game mode and massage mode. The user can play a game and enjoy massage simultaneously.

FIG. 6 shows a massage chair controller capable of providing games according to a second embodiment of the present invention. The second embodiment is identical to the first embodiment-except that the controller 6 includes a wireless form. The controller 6 includes a transceiver 80 formed thereon. The chair 1 also includes a transceiver (not shown) corresponding to the transceiver 80. The transceiver of the chair 1 is connected with the vibrators 2. The massage module 73 transmits a signal through the transceiver 80. The vibrators 2 receive the signal through the transceiver of the chair 1. Thus, the controller 6 controls the vibrators 2.

The present invention has been described through detailed illustration of two embodiments. Those skilled in the art can derive variation from the embodiments without departing from the scope of the present invention. Therefore, the embodiments shall not limit the scope of the present invention defined in the claims.

1. A controller for use in a massage chair with vibrators and capable of providing games, the controller comprising:
a display;
an input device for input of commands;
a selection module connected with both of the display and the input device;
a game module connected with the selection module in order to provide various games; and
a massage module connected with the selection module on one hand and connected with the vibrators on the other hand so as to actuate various combinations of the vibrators.

2. The controller according to claim 1 wherein the input device includes at least one button.

3. The controller according to claim 2 wherein the input device includes a group of buttons for control a cursor in the display.

4. The controller according to claim 2 wherein the input device includes a group of buttons representative of various actions in a game.

5. The controller according to claim 2 wherein the input device includes a group of buttons representative of various combinations of the vibrators.

6. The controller according to claim 1 comprising a slot connected with the game module in order to receive a game card.

7. The controller according to claim 1 comprising a built-in game card connected with the game module.

8. The controller according to claim 1 comprising a cable for connecting the massage module with the vibrators.

9. The controller according to claim 1 wherein the controller comprises a wireless transceiver for communication with the vibrators through a corresponding wireless transceiver.
